(19) United States
(12) Patent Application Publication
(10) Pub. No.: US 2007/0174169 A1
(43) Pub. Date: Jul. 26, 2007

(54) METHOD AND APPARATUS FOR FINANCIAL INVESTING

(76) Inventor: Kris Robbins, Topeka, KS (US)

Correspondence Address: LATHROP & GAGE LC, 4845 PEARL EAST CIRCLE, SUITE 300, BOULDER, CO, 80301, US

(21) Appl. No.: 11/623,413

(22) Filed: Jan. 16, 2007

Related U.S. Application Data
(60) Provisional application No. 60/758,785, filed on Jan. 13, 2006.

(51) Int. Cl. G06Q 40/00

(52) U.S. Cl. 705/36 R

(57) ABSTRACT

A method of administering an annuity to create incentives for an annuity holder to perform one or more pre-selected acts includes implementing a policy role to the annuity upon receiving a rider application by the annuity holder, affecting the annuity in a first manner upon implementing the policy role, and affecting the annuity in a second manner upon the one or more pre-selected acts being performed by the annuity holder. In an embodiment, one pre-selected act may include applying for a credit card. A system for implementing an incentive-creating annuity program includes first and second servers in communication via a network. The first server has a processor, an input device, and software for accessing and altering annuity information. The software includes commands for altering the annuity information in a first way upon sending first predetermined data to the second server and altering the annuity information in a second way upon receiving second predetermined data from the second server.

### RELATED APPLICATIONS

This application claims priority to provisional patent Ser. No. 60/758,785, filed Jan. 13, 2006 and incorporated herein by reference.

### BACKGROUND

Annuities are commonly used for future and present payment structures, and especially as investment mechanisms. While annuities are currently structured in numerous ways, there is generally limited flexibility once the structure of an annuity is agreed upon. A method and apparatus that provides increased flexibility in an annuity plan and incentives for performing pre-selected acts would benefit both the annuity's issuer and the annuity's owner.

### SUMMARY

A method of administering an annuity to create incentives for an annuity holder to perform one or more pre-selected acts and a system for implementing an incentive-creating annuity program are disclosed herein. In one embodiment, a method includes implementing a policy role to the annuity upon receiving a rider application by the annuity holder, affecting the annuity in a first manner upon implementing the policy role, and affecting the annuity in a second manner upon the one or more pre-selected acts being performed by the annuity holder.

In one embodiment, a system for implementing an incentive-creating annuity program includes first and second servers in communication via a network. The first server has a processor, an input device, and software for accessing and altering annuity information. The second server has a processor; an input device; and software for obtaining data from and providing data to the first server. The software includes commands for altering the annuity information in a first way upon sending first predetermined data to the second server and altering the annuity information in a second way upon receiving second predetermined data from the second server.

In one embodiment, a method of administering an annuity to create incentives for an annuity holder to perform one or more pre-selected act includes implementing a policy role to the annuity upon receiving a rider application by the annuity holder, adding a bonus amount to the annuity, and adding an additional bonus amount to the annuity upon one or more pre-selected act being performed by the annuity holder. The bonus amount is based on a percentage of salary reduction purchase payments and a contract value as of a given date, and the additional bonus amount is based on a percentage of salary reduction purchase payments and a contract value as of a given date. dr

### BRIEF DESCRIPTION OF THE DRAWINGS

FIG. 1 shows an exemplary process that creates incentives for an annuity holder to perform pre-selected acts.

FIG. 2 shows an exemplary first bonus structure.

FIG. 3 shows an exemplary second bonus structure.

FIG. 4 shows an exemplary block diagram of a system for implementing the process of FIG. 1.

### DETAILED DESCRIPTION

The present method and system administers an annuity to create incentives for an annuity holder to perform one or more pre-selected acts. In one embodiment, a method includes implementing a ‘policy role’ to the annuity upon receiving a rider application by the annuity holder, affecting the annuity in a first manner upon implementing the policy role, and affecting the annuity in a second manner upon one or more pre-selected acts being performed by the annuity holder. A ‘policy role’ may thus define a set of associated conditions and actions for an annuity, where the actions (e.g., the application of a bonus to the annuity) are taken if the associated conditions are met by the annuity holder.

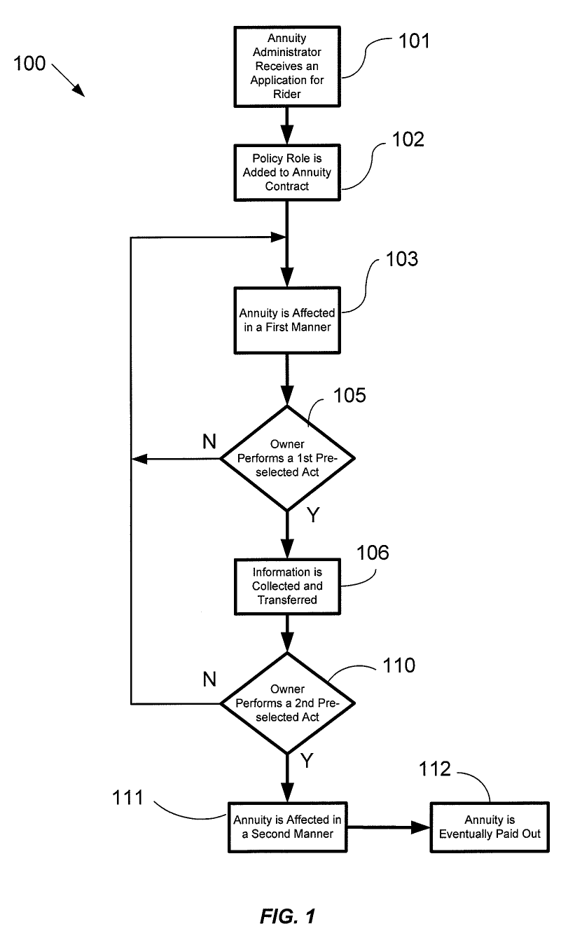

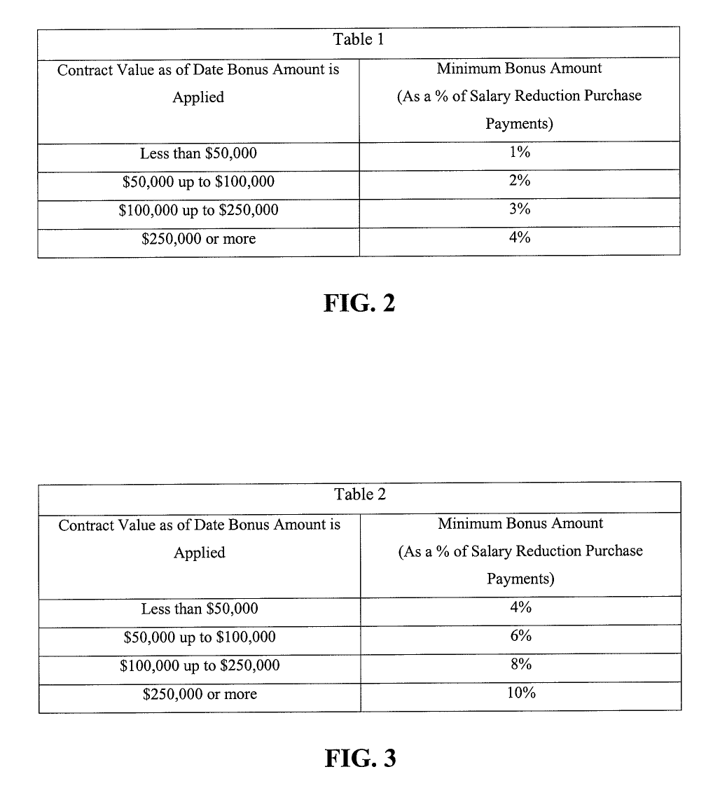

FIG. 1 shows an exemplary process 100 that creates incentives for an annuity holder to perform certain pre-selected acts. In the example of FIG. 1, at step 101, an annuity administrator receives an application for a policy rider, either with an application for a new annuity or for an annuity already in existence. At step 102, the administrator may then add a policy role to an appropriate new or existing contract indicating that the annuity is affected in a first manner as shown in step 103. For example, the contract holder may begin receiving a bonus, such as according to the bonus structure depicted in FIG. 2. If, in step 105, the contract holder (also referred to herein as “owner”) does not perform a pre-selected act (e.g., applying for a credit card) the annuity may continue to be affected in the first manner in step 103. If, in step 105, the owner does perform a first pre-selected act (e.g., applying for a credit card) the administrator may collect information from the owner and transfer the information to another party (e.g., a credit card company,) as shown at step 106.

If, in step 110, a second pre-selected event does not occur, the annuity may continue to be affected in the first manner in step 103. If, in step 110, a pre-selected event (e.g., the administrator receiving notification of credit card approval) does occur, however, the owner becomes closer to having the annuity affected in a second manner, as shown at step 111. The second manner may include, for example, an additional bonus to the annuity, such as according to the bonus structure depicted in FIG. 3. Before the annuity is affected in the second manner, the owner may have to perform a second pre-selected act (e.g., using an issued credit card,) as shown at step 110. If the owner does not perform the second pre-selected act as shown at step 110 (e.g., using an issued credit card) the annuity may continue to be affected in the first manner 103. It should be appreciated that the owner may perform the first pre-selected act at step 105 (e.g., applying for a credit card) concurrently with step 101, in which case steps 102, 103, and 106 may occur such that process 100 proceeds to step 110 to await occurrence of the second pre-selected act.

Step 112 shows the annuity eventually being paid out, though it should be understood that the annuity may be paid out after only being affected in the first manner at step 103 or without the owner ever applying for the rider at step 101. The annuity being affected in the first manner at step 103 and in the second manner at step 111 alters the size of the annuity (e.g., how much the annuity pays out or when the annuity may be paid out) rather than whether the annuity is eventually paid out or not.

An annuity being affected in the second manner (e.g., in accordance with FIG. 3) may no longer be affected in the second manner if any of certain pre-determined events occur (e.g., administrator is notified that the credit card is inactive or canceled). However, such an annuity may again be affected in the second manner upon a corresponding redeeming event occurring (e.g., administrator is notified that credit card is active or reactivated). The administrator may further have the option of terminating the rider either with or without conditions.

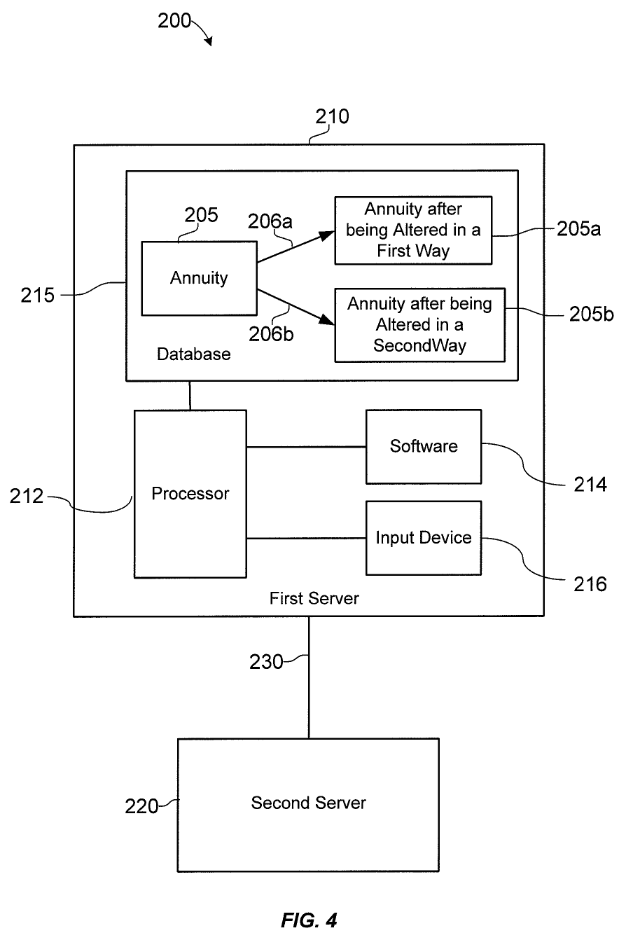

FIG. 4 shows a system 200 for implementing process 100. System 200 includes first and second servers 210, 220 in communication via a network 230, for example. First server 210 includes a processor 212, software 214, and an input device 216. Server 210 executes software 214 utilizing data obtained through input device 216, database 215, and from server 220, and server 220 performs functions described below. Data obtained through input device 216 includes data relating to a rider application. Software 214 includes commands for requesting, storing, and sharing data and commands for accessing and altering annuity information. As shown in FIG. 4, data stored in database 215 includes annuity information 205, 205a, 205b.

The annuity may be increased by a greater percentage when software 214 alters annuity information in the second way instead of the first way as an incentive for the owner to perform pre-selected acts, such as at steps 105 and 110 in FIG. 1. This may be seen by comparing blocks 205a and 205b in FIG. 4. When an annuity 205 is increased by software 214 in a first way, an annuity 205a that is larger than annuity 205 results. Line 206a represents the transformation process of software 214 increasing annuity 205 in the first way (e.g., applying a first bonus amount to annuity 205). When annuity 205 is increased by software 214 in a second way, an annuity 205b that is larger than annuity 205 and annuity 205a, respectively, results. Line 206b represents the transformation process of software 214 increasing annuity 205 in the second way (e.g., applying a second bonus amount to annuity 205). While blocks 205a and 205b are not presented to scale, they appropriately show annuity 205b as being larger than annuity 205a.

FIG. 2 shows an exemplary first bonus structure, and FIG. 3 shows an exemplary second bonus structure. Software 214 includes functionality for providing data (e.g., credit card application data) to second server 220, receiving data (e.g., credit card approval data) from second server 220, altering annuity information in a first way (e.g., in accordance with the first bonus structure shown in FIG. 2) upon sending predetermined data (e.g., credit card application data) to second server 220, and altering annuity information in a second way (e.g., in accordance with the second bonus structure shown in FIG. 3) upon receiving other predetermined data (e.g., credit card approval data) from second server 220. Software 214 may also include commands for altering annuity information from the second way to the first way upon receiving different predetermined data (e.g., that a credit card is not active) from second server 220.

Those skilled in the art appreciate that variations from the specified embodiments disclosed above are contemplated herein. The description should not be restricted to the above embodiments, but should be measured by the following claims.

What is claimed is:

1. A method of administering an annuity to create incentives for an annuity holder to perform one or more pre-selected acts, said method comprising:
implementing a policy role to the annuity upon receiving a rider application by the annuity holder;
affecting the annuity in a first manner upon implementing the policy role; and
affecting the annuity in a second manner upon said one or more pre-selected acts being performed by the annuity holder.

2. The method of claim 1, wherein the annuity holder may perform a second pre-selected act only after performing a first pre-selected act and only after a first pre-selected event occurs.

3. The method of claim 2, wherein:
the first pre-selected act includes applying for a credit card;
the first pre-selected event includes obtaining approval for a the credit card; and
the second pre-selected act includes using the credit card.

4. The method of claim 3, wherein affecting the annuity in the first manner includes affecting the annuity by applying a first bonus amount thereto, wherein the first bonus amount is a function of the annuity value as of the date the first bonus amount is applied.

5. The method of claim 4, wherein affecting the annuity in the second manner includes affecting the annuity by applying a second bonus amount thereto, wherein the second bonus amount is a function of the annuity value as of the date the bonus amount is applied.

6. The method of claim 1, wherein the annuity receives a greater bonus percentage when affected in the second manner than when affected in the first manner.

7. A method of administering an annuity to create incentives for an annuity holder to perform one or more pre-selected acts, said method comprising:
implementing a policy role to the annuity upon receiving a rider application by the annuity holder;
affecting the annuity in a first manner upon implementing the policy role;
affecting the annuity in a second manner upon said one or more pre-selected acts being performed by the annuity holder;
performing a first pre-selected act including applying for a credit card and obtaining approval for the credit card; and
the second pre-selected act including using the credit card;
wherein the annuity holder may perform the second pre-selected act only after performing the first pre-selected act;
wherein affecting the annuity in the first manner includes affecting the annuity by applying a first bonus amount thereto, wherein the first bonus amount is a function of the annuity value as of the date the first bonus amount is applied, and
wherein affecting the annuity in the second manner includes affecting the annuity by applying a second bonus amount thereto, wherein the second bonus amount is a function of the annuity value as of the date the bonus amount is applied.

8. A system for implementing an incentive-creating annuity program, the system comprising:
a first server having a processor, a database containing annuity information, and software for accessing and altering the annuity information; and
a second server, in communication with the first server via a network, for obtaining data from and providing data to the first server;
wherein the first server software includes commands for:
altering the annuity information in a first way upon sending first predetermined data to the second server; and
altering the annuity information in a second way upon receiving second predetermined data from the second server.

9. The system of claim 8, wherein the first server software performs functions including:
providing credit card application data to the second server;
receiving credit card approval data from the second server;
altering the annuity information in the first way upon sending the credit card application data to the second server; and
altering the annuity information in the second way upon receiving the credit card approval data from the second server.

10. The system of claim 9, wherein altering the annuity in the first way includes affecting the annuity by applying a first bonus amount thereto, wherein the first bonus amount is a function of the annuity value as of the date the first bonus amount is applied; and wherein altering the annuity in the second way includes affecting the annuity by applying a second bonus amount thereto, wherein the second bonus amount is a function of the annuity value as of the date the bonus amount is applied.

11. A method of administering an annuity to create incentives for an annuity holder to perform one or more pre-selected acts, said method comprising:
implementing a policy role to the annuity upon receiving a rider application by the annuity holder;
adding a bonus amount to the annuity based on a percentage of salary reduction purchase payments and a contract value as of a given date; and
adding an additional bonus amount to the annuity based on a percentage of salary reduction purchase payments and a contract value as of a given date upon one or more pre-selected acts being performed by the annuity holder.

12. The method of claim 11, wherein the one or more pre-selected acts include:
applying for a credit card; and
making a purchase with the credit card.
